(19) United States
(12) Patent Application Publication
(10) Pub. No.: US 2026/0091828 A1
(43) Pub. Date: Apr. 2, 2026

(54) VEHICLE BODY FASTENING STRUCTURE

(71) Applicant: TOYOTA JIDOSHA KABUSHIKI KAISHA, Aichi-ken (JP)

(72) Inventor: Shigenori HASHIDA, Nisshin-shi (JP)

(21) Appl. No.: 19/271,790

(22) Filed: Jul. 17, 2025

(30) Foreign Application Priority Data
Oct. 2, 2024 (JP) 2024-173272

(51) Int. Cl. B62D 27/02; B62D 25/20

(52) U.S. Cl. CPC B62D 27/023; B62D 25/2036

(57) ABSTRACT

The vehicle body fastening structure is applied to the side sill and the vehicle body. The side sill is formed by extrusion and has a first projecting portion extending in a first direction. The vehicle body constitutes another part of the vehicle and is formed by casting, and has a second projecting portion extending in a second direction orthogonal to the first direction. The first projecting portion and the second projecting portion are joined by fastening in a state in which the surface of the first projecting portion on the protruding direction distal end side and the surface of the second projecting portion on the protruding direction distal end side are in contact with each other.

### CROSS-REFERENCE TO RELATED APPLICATION

This application claims priority to Japanese Patent Application No. 2024-173272 filed on Oct. 2, 2024. The disclosure of the above-identified application, including the specification, drawings, and claims, is incorporated by reference herein in its entirety.

### BACKGROUND

### 1. Technical Field

The present disclosure relates to a vehicle body fastening structure.

### 2. Description of Related Art

Japanese Unexamined Patent Application Publication No. 2015-101191 (JP 2015-101191 A) discloses a vehicle body lower-side structure of a vehicle that achieves improvement in relative mounting precision between a side sill cover panel and a fender panel. The vehicle body lower side structure for a vehicle described in this literature includes a side sill, a side sill cover panel, and a fender panel. The side sill makes up a lower side portion of the vehicle body and extends in a front-rear direction of the vehicle body. The side sill cover panel covers the side sill from outside, so as to form a portion of an outer face of the vehicle body. The fender panel forms another portion of the outer face of the vehicle body, adjacent a front portion of the side sill. Also, a bracket extending forward of the side sill is supported at a front end portion of the side sill. Also, attaching each of the side sill cover panel and the fender panel to an extending portion of the bracket enables relative mounting precision between the side sill cover panel and the fender panel to be improved.

### SUMMARY

Now, a first vehicle body component part that is formed by casting or extrusion molding and a second vehicle body component part that is formed by casting or extrusion molding are fixed by fastening in some cases. In such a case, it is conceivable that the first vehicle body component part and the second vehicle body component part may interfere with each other at portions other than a fastening portion due to variance in shape of each part. However, the configuration that is described in JP 2015-101191 A does not take this point into consideration.

Taking the foregoing circumstances into account, it is an object of the present disclosure to provide a vehicle body fastening structure that is capable of suppressing interference between the first vehicle body component part and the second vehicle body component part at portions other than the fastening portion.

A vehicle body fastening structure according to a first aspect includes a first vehicle body component part that makes up a portion of a vehicle and that also is fashioned by casting or extrusion molding, the first vehicle body component part including a first projecting portion that extends in a first direction, and
a second vehicle body component part that makes up another portion of the vehicle and that also is fashioned by casting or extrusion molding, the second vehicle body component part including a second projecting portion that extends in a second direction orthogonal to the first direction.

The first projecting portion and the second projecting portion are joined by fastening in a state in which a face of the first projecting portion on a distal end side in a protruding direction of the first projecting portion, and a face of the second projecting portion on a distal end side in a protruding direction of the second projecting portion, are in contact with each other.

In the vehicle body fastening structure of the first aspect, the first projecting portion and the second projecting portion are joined by fastening in the state in which the face of the first projecting portion of the first vehicle body component part on the distal end side in the protruding direction thereof, and the face of the second projecting portion of the second vehicle body component part on the distal end side in the protruding direction thereof, are in contact with each other. In this configuration, even when there is variance in shape due to casting or extrusion molding, interference between the first vehicle body component part and the second vehicle body component part can be suppressed at portions other than the first projecting portion and the second projecting portion that are fastening portions.

In the vehicle body fastening structure of the first aspect,
the first vehicle body component part may be a side sill that is fashioned by extrusion molding and includes the first projecting portion that extends in a vehicle front-rear direction and protrudes toward a vehicle upward side, and
the second vehicle body component part may be a vehicle body that is fashioned by casting and includes the second projecting portion that extends in a vehicle width direction and protrudes toward a vehicle downward side.

In the vehicle body fastening structure above, the first projecting portion and the second projecting portion are joined by fastening in the state in which the face on the distal end side in the protruding direction of the first projecting portion of the side sill, and the face on the distal end side in the protruding direction of the second projecting portion of the vehicle body, are in contact with each other. In this configuration, even when there is variance in shape due to casting or extrusion molding, interference between the side sill and the vehicle body can be suppressed at portions other than the first projecting portion and the second projecting portion that are fastening portions.

The vehicle body fastening structure according to the present disclosure has an excellent effect in that interference between the first vehicle body component part and the second vehicle body component part can be suppressed at portions other than the fastening portion.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically showing a first fastening portion between a vehicle body and a side sill;

FIG. 2 is a cross-sectional view illustrating a cross section of a first fastening portion between a vehicle body and a side sill cut along a vehicle up-down direction and a vehicle width direction;

FIG. 3 is a cross-sectional view showing a cross section in which a second fastening part between a vehicle body and a side sill is cut along a vehicle up-down direction and a vehicle width direction; and

FIG. 4 is a cross-sectional view illustrating a cross section of a first fastening portion of the vehicle body and the side sill cut along the vehicle up-down direction and the front-rear direction.

### DETAILED DESCRIPTION OF EMBODIMENTS

Hereinafter, a vehicle body fastening structure according to an embodiment of the present disclosure will be described with reference to the drawings. Note that the arrow FR appropriately shown in the drawings indicates the vehicle front side, the arrow UP indicates the vehicle upward direction side, the arrow LH indicates the left side in the vehicle width direction (left-right direction), and the arrow RH indicates the right side in the vehicle width direction (left-right direction). Further, in the case of indicating the longitudinal, vertical, and lateral directions without any special description in the following description, it is assumed that the longitudinal, vertical, and lateral directions of the vehicle front-rear direction, the up-down direction of the vehicle, and the lateral direction of the vehicle.

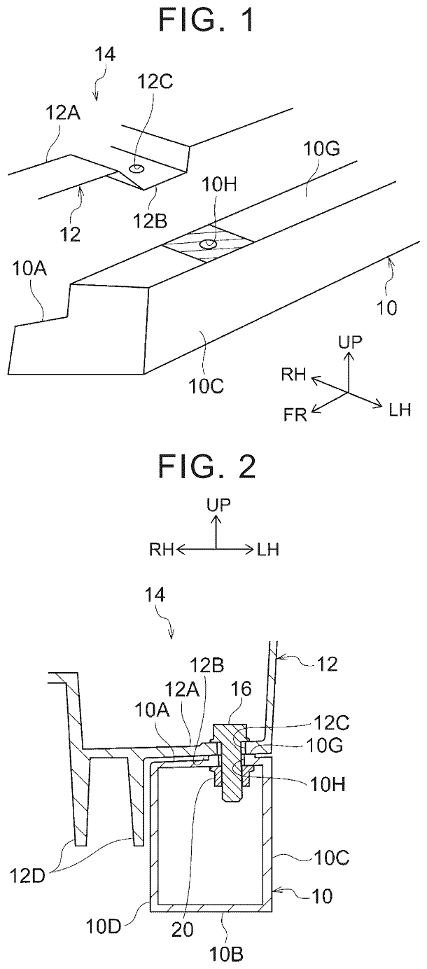

FIG. 1 is an exploded perspective view of a first fastening portion 14 of a left side sill 10 of a vehicle and a vehicle body 12. As an example, the side sill 10 is formed by extrusion molding using a metal material such as an aluminum alloy. Also. As an example, the vehicle body 12 is formed by casting using a metal material such as an aluminum alloy.

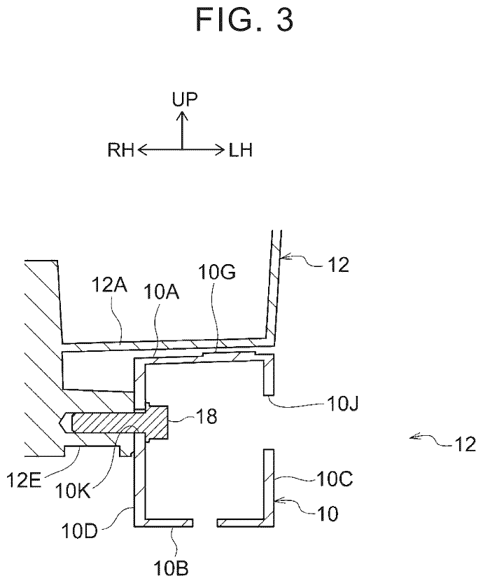

More specifically, as shown in FIGS. 2 and 3, the side sill 10 is formed in an elongated shape extending in the front-rear direction at an end portion of the lower portion of the vehicle on the outer side in the vehicle width direction. The side sill 10 includes an upper wall portion 10A extending in the front-rear direction with the up-down direction as the thickness direction, and a lower wall portion 10B extending in the front-rear direction with the up-down direction as the thickness direction on the downward side of the upper wall portion 10A. The side sill 10 includes an outer wall portion 10C and an inner wall portion 10D. The outer wall portion 10C connects an end portion of the upper wall portion 10A on the outer side (left side) in the vehicle width direction and an end portion of the lower wall portion 10B on the outer side in the vehicle width direction in the up-down direction. The inner wall portion 10D connects an end portion of the upper wall portion 10A on the vehicle width direction inner side (right side) and an end portion of the lower wall portion 10B on the vehicle width direction inner side in the up-down direction.

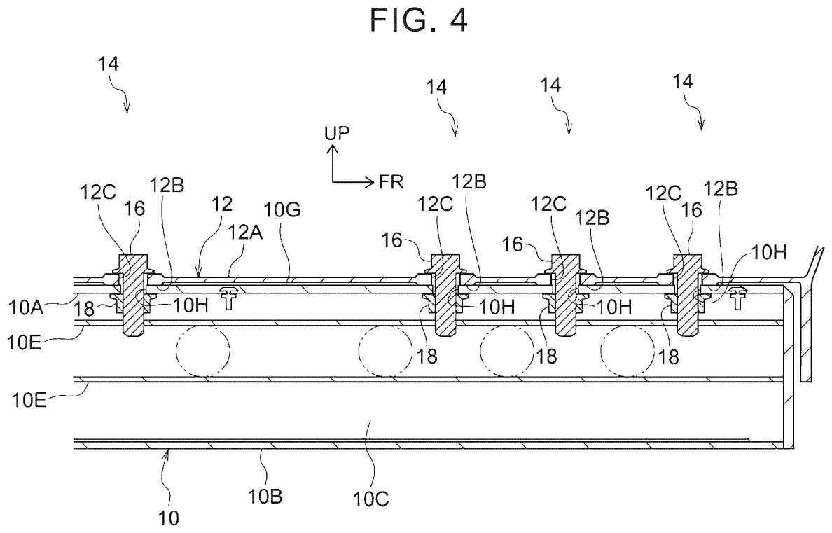

As illustrated in FIGS. 1 to 4, the side sill 10 includes a first projecting portion 10G that protrudes upward from a vehicle-width-direction-outer portion of the upper wall portion 10A. In FIG. 1, the protruding amount of the first projecting portion 10G with respect to the upper wall portion 10A is exaggerated. The first projecting portion 10G extends without interruption in the front-rear direction. A bolt insertion hole 10H into which the bolt 16 is inserted is formed in the upper wall portion 10A and the first projecting portion 10G. In the present embodiment, the plurality of bolt insertion holes 10H into which the plurality of bolts 16 are respectively inserted are arranged at intervals in the front-rear direction. Further, as shown in FIGS. 3 and 4, in the outer wall portion 10C and the vertical wall portion 10F, a plurality of bolt passing holes 10J are formed in a position offset in the front-rear direction with respect to the plurality of bolt insertion holes 10H (a portion surrounded by a two-dot chain line in FIG. 4). The plurality of bolts 18 pass through the plurality of bolt passing holes 10J. Further, a plurality of bolt insertion holes 10K into which a plurality of bolts 18 are respectively inserted are formed at positions corresponding to the plurality of bolt passing holes 10J formed in the outer wall portion 10C and the vertical wall portion 10F in the inner wall portion 10D.

As illustrated in FIGS. 2 to 4, the vehicle body 12 includes a joint-wall portion 12A extending along the front-rear direction with the up-down direction as the thickness direction. The area extending from the center portion in the left-right direction to the end portion on the outer side in the vehicle-width direction in the joint wall portion 12A extends along the upper wall portion 10A of the side sill 10 on the upward side of the side sill 10. As illustrated in FIGS. 1, 2, and 4, the vehicle body 12 includes a plurality of second projecting portions 12B protruding downward from the joint-wall portion 12A. In FIG. 1, the protruding amount of the second projecting portion 12B with respect to the joint-wall portion 12A is exaggerated. The plurality of second projecting portions 12B are disposed opposite in the up-down direction to the plurality of first projecting portions 10G provided on the side sill 10. The second projecting portion 12B extends uninterruptedly in the left-right direction, which is a direction perpendicular to the front-rear direction. A plurality of bolt insertion holes 12C into which a plurality of bolts 16 are respectively inserted are formed in the joint-wall portion 12A and the second projecting portion 12B. In addition, the vehicle body 12 includes a pair of ribs 12D protruding downward from a portion on the vehicle-width-direction inner side in the joint-wall portion 12A. The pair of ribs 12D are spaced apart from each other in the vehicle-width direction. Further, as shown in FIG. 3, the vehicle body 12 includes a plurality of boss portions 12E into which a plurality of bolts 18 respectively inserted into a plurality of bolt insertion holes 10K formed in the inner wall portion 10D of the side sill 10 are respectively screwed.

As shown in FIGS. 1 to 4, in the configuration of the present embodiment described above, the bolt 16 is screwed to each of the plurality of nuts 20 provided in the side sill 10. The bolt 16 is a bolt 16 inserted into a plurality of bolt insertion holes 12C on the vehicle body 12 side and a plurality of bolt insertion holes 10H on the side sill 10 side. As a result, the first projecting portion 10G and the second projecting portion 12B are fastened together with the surface (upper surface) of the side sill 10 on the distal end side in the protruding direction of the first projecting portion 10G and the surface (lower surface) on the distal end side in the protruding direction of the second projecting portion 12B of the vehicle body 12 being in contact with each other. The fastening portion between the first projecting portion 10G and the second projecting portion 12B is referred to as a first fastening portion 14. In this configuration, even if variations in shapes are caused by casting or extrusion, it is possible to suppress the side sill 10 and the vehicle body 12 from interfering with each other in portions other than the first projecting portion 10G and the second projecting portion 12B, which are the first fastening portions 14. For example, variations in shapes may occur in the joint wall portion 12A of the vehicle body 12 and the upper wall portion 10A of the side sill 10. Even in such cases, it is possible to suppress the side sill 10 and the vehicle body 12 from interfering with each other at a portion other than the first projecting portion 10G and the second projecting portion 12B, which are the first fastening portions 14.

Further, the bolts 18 inserted into the plurality of bolt inserting holes 10K on the side sill 10 side are respectively screwed into the plurality of boss portions 12E provided on the vehicle body 12 side. As a result, the inner wall portion 10D and the boss portion 12E are joined by fastening while the inner wall portion 10D of the side sill 10 and the boss portion 12E of the vehicle body 12 are in contact with each other. The fastening portion between the inner wall portion 10D and the boss portion 12E is referred to as a second fastening portion 22. As described above, by providing the second fastening portion 22 in addition to the first fastening portion 14, the vehicle body 12 can be firmly fixed by the side sill 10.

In the present embodiment, an example in which the vehicle body fastening structure according to the present disclosure is applied to the fastening portion between the side sill 10 and the vehicle body 12 has been described, but the present disclosure is not limited thereto. The vehicle body fastening structure according to the present disclosure can be applied to a fastening portion between a first vehicle body component part formed by casting or extrusion molding and a second vehicle body component part formed by casting or extrusion molding.

Although an embodiment of the present disclosure has been described above, the present disclosure is not limited to the above, and it is needless to say that the present disclosure can be implemented with various modifications other than the above without departing from the gist thereof.

What is claimed is:

1. A vehicle body fastening structure, comprising:
a first vehicle body component part that makes up a portion of a vehicle and that also is fashioned by casting or extrusion molding, the first vehicle body component part including a first projecting portion that extends in a first direction; and
a second vehicle body component part that makes up another portion of the vehicle and that also is fashioned by casting or extrusion molding, the second vehicle body component part including a second projecting portion that extends in a second direction orthogonal to the first direction; wherein
the first projecting portion and the second projecting portion are joined by fastening in a state in which a face of the first projecting portion on a distal end side in a protruding direction of the first projecting portion, and a face of the second projecting portion on a distal end side in a protruding direction of the second projecting portion, are in contact with each other.

2. The vehicle body fastening structure according to claim 1, wherein
the first vehicle body component part is a side sill that is fashioned by extrusion molding and includes the first projecting portion that extends in a vehicle front-rear direction and protrudes toward a vehicle upward side, and
the second vehicle body component part is a vehicle body that is fashioned by casting and includes the second projecting portion that extends in a vehicle width direction and protrudes toward a vehicle downward side.
